(19) United States
(12) Patent Application Publication
(10) Pub. No.: US 2005/0004828 A1
(43) Pub. Date: Jan. 6, 2005

(54) System and method for preference scheduling of staffing resources

(76) Inventors: Anura H. deSilva, Bethesda, MD (US); Jonathan F. Bard, Austin, TX (US); Robert Carignan, Quebec City (CA); Daniil Yakimovich, Greenbelt, MD (US); Galip M. Karabulut, Fairfax, VA (US); Hadi W. Purnomo, Austin, TX (US); Abhinav Sharma, Silver Spring, MD (US); Sonali N. Jayawardena, Silver Spring, MD (US); Songul Ozdemir, Arlington, VA (US)

Correspondence Address: COOLEY GODWARD LLP;ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/852,435

(22) Filed: May 25, 2004

Related U.S. Application Data
(60) Provisional application No. 60/473,200, filed on May 27, 2003.

(51) Int. Cl. G06F 19/00

(52) U.S. Cl. 705/9; 700/100

(57) ABSTRACT

The invention provides a system and method for scheduling resources. In one respect, embodiments of the invention allow workers to indicate preferences for specific shifts during a planning horizon, within limitations imposed by the scheduling system. Embodiments of the system and method seek to meet all hard constraints, and utilize a flexible scoring technique to minimize the violation of soft constraints. Embodiments also consider the substitution of higher skilled workers in cases where there is an unmet demand for lower skilled workers.

### BACKGROUND

The invention relates generally to the field of operations management. More specifically, the invention relates to a system and method for providing an improved ability to schedule staffing resources (hereinafter staff, resources, employees, or workers).

Human resource scheduling is of great importance in many industries. In the health care services industry, for example, scheduling the appropriate quantity and type of nurses for each shift in a hospital is critical to providing quality patient care. In the banking industry, a minimum number of tellers are needed to provide an acceptable level of customer service in a branch bank. In manufacturing operations, a precise number of workers with the appropriate skills may be needed to keep an assembly line balanced. Similar requirements exist in other industries.

Resource planning is made complex by a variety of scheduling constraints. Some of the most severe constraints are legally based. Employers are bound by certain government regulations, for instance, and may also be obligated under contracts with employees, contractors, or labor unions.

Known systems and methods for scheduling staff resources have many disadvantages. For example, manual methods are labor intensive, and do not adequately highlight situations where the foregoing scheduling constraints, and others, are violated. Automated systems can be inflexible in terms of the logic used to perform scheduling and may produce sub-optimal results. Moreover, many known automated systems provide little or no opportunity for the staff being scheduled to input individual scheduling preferences, leading to decreased worker satisfaction and increased absenteeism.

What is needed is an improved planning system and method that is both robust and flexible in its scheduling algorithm, and provides an opportunity for input from the staffing resources being scheduled.

### SUMMARY OF THE INVENTION

The invention provides a system and method for scheduling resources. In one respect, embodiments of the invention allow workers to indicate preferences for specific shifts during a planning horizon, within limitations imposed by the scheduling system. As used herein, a shift may be or include full time hours, part-time hours, or overtime hours.

In another respect, embodiments of the invention improve the way that staff schedules are optimized by distributing resources over the planning horizon in proportion to demand, to the extent possible. Embodiments of the system and method seek to meet all hard constraints imposed by a user, and utilize a flexible scoring technique to minimize the violation of soft constraints. Embodiments also consider the substitution of higher skilled workers in cases where there is an unmet demand for lower skilled workers.

In another respect, embodiments of the invention allow for adjustments to be made to an optimized schedule within the planning horizon without the need to replan all resources.

Embodiments of the invention provide a method for scheduling a plurality of staff, including: receiving scheduling constraints; preparing an initial schedule based on the scheduling constraints, the preparing based on a resource preference of at least one of the plurality of staff; receiving scheduling strategies, the scheduling strategies being selectively input; and optimizing the initial schedule based on the received scheduling strategies to produce an optimized schedule.

Embodiments of the invention provide a method for scheduling a plurality of staff, including: preparing a staff schedule for a first time horizon; and optimizing the staff schedule for a second time horizon, the second time horizon being shorter than the first time horizon, the optimizing being based on a cost parameter.

Embodiments of the invention provide a method for optimizing a staffing schedule, including: selecting a first resource type in the staffing schedule; generating a first alternative schedule for the first resource type; determining whether the first alternative schedule for the first resource type meets a predetermined plurality of hard constraints; and if the first alternative schedule for the first resource type meets the predetermined plurality of hard constraints, calculating a first penalty score based on a first deviation from a plurality of soft constraints, the plurality of hard constraints being mandatory scheduling criteria, the plurality of soft constraints being optional scheduling criteria.

Embodiments of the invention provide a method for producing a staffing schedule, including: identifying a first staff schedule, the first staff schedule being a candidate to swap with a second staff schedule, the first staff schedule being associated with a first staff person, the second staff schedule being associated with a second staff person, the first staff schedule and the second staff schedule being portions of the staff schedule; sending a private message from the first staff person to the second staff person offering a swap between at least a portion of the first staff schedule and at least a portion of the second staff schedule; and updating the staff schedule based on the private message.

Embodiments of the invention provide a method for suggesting staffing changes, including: calculating at least one of overstaffing and understaffing for a shift; specifying at least one of a modification limit and an addition limit, the modification limit based on at least one of a skill type and a shift pattern, the addition limit based on a quantity of staff that can be one of added and reduced; and determining whether the modification limit is zero.

Embodiments of the invention provide a machine-readable medium having instructions stored thereon for execution by a processor to perform one or more of the methods described above.

The features and advantages of the invention will become apparent from the following drawings and detailed description.

### BRIEF DESCRIPTION OF THE DRAWINGS

Embodiments of the invention are described with reference to the following drawings, wherein:

FIG. 1 is a process flow diagram for a staff scheduling method, according to an embodiment of the invention;

FIG. 2 is a process flow diagram for the initial scheduling step shown in FIG. 1, according to an embodiment of the invention;

FIG. 3 is a process flow diagram for the optimization step shown in FIG. 1, according to an embodiment of the invention;

FIG. 4 is an illustration of a table used in scoring violations of scheduling constraints, according to an embodiment of the invention;

FIG. 5 is a process flow diagram for the daily scheduling step in FIG. 1, according to an embodiment of the invention;

FIG. 6 is a process flow diagram for the daily optimization step in FIG. 5, according to an embodiment of the invention;

FIG. 7 is an illustration of a table used for assigning costs to scheduling dissatisfactions, according to an embodiment of the invention;

FIG. 8 is a process flow diagram for the shift-swap messaging step in FIG. 1, according to an embodiment of the invention;

FIG. 9 is a process flow diagram for suggesting modifications to staffing resources, according to an embodiment of the invention; and

FIG. 10 is a block diagram of a functional architecture for a scheduling system, according to an embodiment of the invention.

### DETAILED DESCRIPTION

The invention is described with reference to process flow diagrams illustrating various scheduling components, then with reference to a functional architecture that can be configured to perform one or more of the scheduling processes.

As used herein, except where otherwise specified, forms of the word “optimum” (including, but not limited to, optimize, optimized, optimizer, optimal, and optimization) refer to a relative degree or amount of improvement and not necessarily the greatest degree of improvement possible. As used herein, a unit is an operational unit of a work force such as a work group, division, or other level of organization.

Sub-headings are used below for organizational convenience, but do not necessarily limit the disclosure of any particular feature to any particular section of this specification. We begin with an overview of several processes that can be used in combination.

Overview

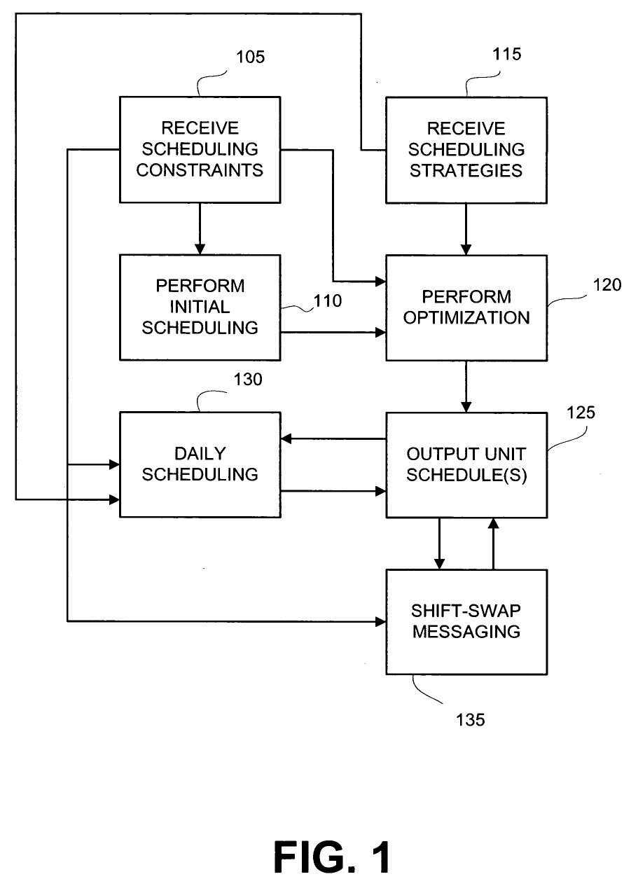

FIG. 1 is a process flow diagram for a staff scheduling method, according to an embodiment of the invention. As shown therein, optimization step 120 is preceded by step 105 for receiving schedule constraints, step 110 for developing an initial schedule, and step 115 for receiving scheduling strategies. In addition, FIG. 1 illustrates that unit schedules output in step 125 may be altered by daily scheduling step 130 and/or by shift-swap messaging step 135.

Initial scheduling step 110, optimization step 120, and shift-swap messaging step 135 are performed for a predetermined planning horizon. As an example, the planning horizon may be a week or a month. In one embodiment, the planning horizon is the same period of time for each of steps 110, 120, and 135. In an alternative embodiment, the planning horizon of optimization step 120 is a sub-set of the planning horizon for initial scheduling step 110. In the alternative, or in combination, the planning horizon for shift-swap messaging step 135 is a sub-set of the planning horizon for optimization step 120. In the illustrated embodiment, daily scheduling step 130 is for one or more shifts, and is typically for a sub-set of the planning horizon for optimization step 120.

Scheduling constraints received in step 105 may include, for example, staff preferences, staff hired profiles, demand profiles, scheduling guidelines, and history. Staff preferences may include, by way of example and not limitation, data such as the time of day and/or the day of week that a worker prefers to work or not to work. Staff hired profiles may include, for instance, a service date or other indication of seniority, a designation of employee status as a full or part-time worker, and/or a skills classification. A demand profile would be, for example, the quantity of each skills classification required per shift. Scheduling guidelines may include a permission relating to granted time off, federal and state labor laws, contractual obligations, labor costs, or other information. History refers to shifts worked by, or scheduled for, resources over one or more time periods preceding the planning horizon.

Data relating to staff preferences, staff hired profiles, demand profiles, scheduling guidelines and history may be further classified as either hard constraints or soft constraints, according to management choice. The effect of a classification of data as a hard constraint is that rules related to hard constraints will not be violated by the scheduling system. Rules related to soft constraints may be violated in some circumstances, but such instances will be minimized.

Initial scheduling step 110 may be performed according to either of two embodiments. In a first embodiment, initial scheduling step 110 advantageously facilitates interaction with staffing resources that are subject to scheduling, within certain limitations. In a second embodiment of initial scheduling step 110, a schedule is developed without the interaction of any staff.

Scheduling strategies received in step 115 are based on optimization criteria supplied by a supervisor, manager, or other administrator (used interchangeably herein) that is responsible for scheduling a group of workers. This feature advantageously provides flexibility in how the optimization process in step 120 will be performed. For example, whereas the optimization step 120 might normally be configured to minimize staff shortages equally on all shifts, a scheduling strategy for a particular planning horizon may additionally include a constraint that a particular shift within the planning horizon is fully staffed. As another example, a strategy for a particular planning horizon may require first staffing night shifts, then weekend shifts, then day shifts.

Optimization step 120 receives scheduling constraints from step 105, an initial schedule from step 110, and may receive scheduling strategies from step 115. Step 120 then performs an optimization of the initial schedule to help put one or more unit schedules in step 125.

Daily scheduling step 130 provides a mechanism for managers, supervisors, or other administrators to make adjustments in the schedule for one or more shifts where, for example, circumstances have changed in the demand for resources, or available supply of resources, on one or more shifts. Step 130 may receive the unit schedules from step 125, including the changes that result from shift swapping step 135. Step 130 may also receive scheduling constraints from step 105 and scheduling strategies from step 115. Step 130 then optimizes the unit schedules to provide partial and/or full shift assignments for the available staff.

Shift swap messaging step 135 relates to staff-requested adjustments to one or more shifts within the planning horizon. In the illustrated embodiment, the adjustment is a proposed swap of shift between two workers. In another embodiment shift-swap messaging could be replaced with a request to add or drop a shift; in other words, a worker could seek to decrease or increase their scheduled shifts or hours within the planning horizon of the unit schedule output in step 125. In the alternative, or in combination with other embodiments already described, messaging step 135 can include a method for communicating the output unit schedule to staff.

Step 105 for receiving scheduling constraints and step 110 for performing initial scheduling may be performed together without any of the other illustrated steps. In addition, optimization step 120 may be performed with only the benefit of step 105 for receiving scheduling constraints and step 115 for receiving scheduling strategies. Moreover, the unit schedule's output in step 125 may stand without modification, or may be modified by daily scheduling step 130 and/or shift swap messaging step 135. Further, daily scheduling step 130 and/or shift swap messaging step 135 could be performed on a stand alone basis using a schedule prepared by a process other than optimization step 120.

Initial Scheduling

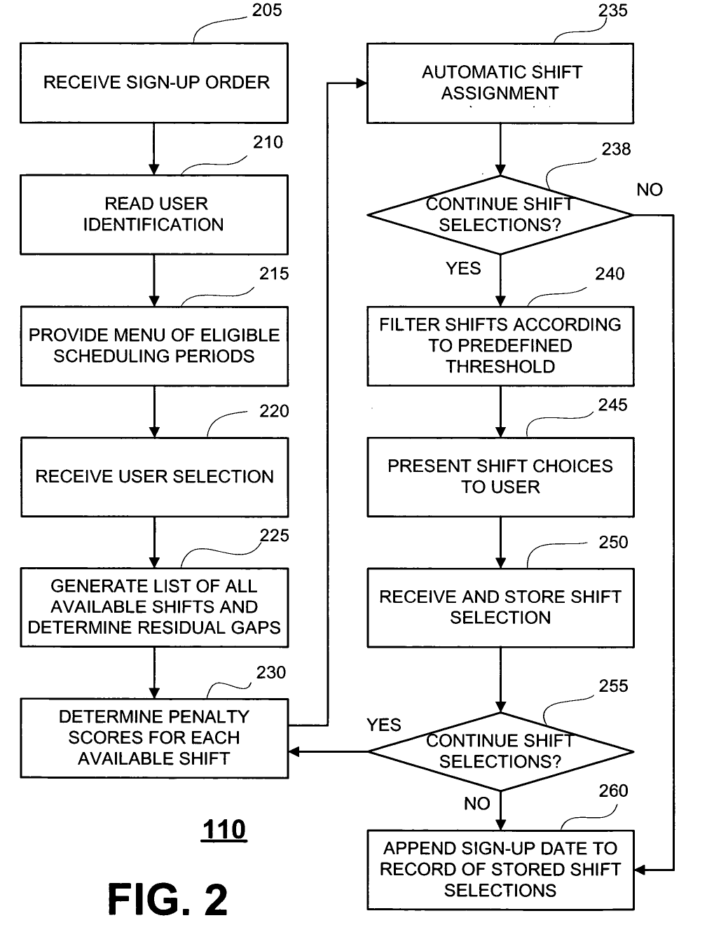

FIG. 2 is a process flow diagram for the initial scheduling step 110 shown in FIG. 1, according to an embodiment of the invention. In the interactive mode illustrated in FIG. 2, the system receives a sign up order in step 205 which indicates, for example, a span of dates and/or times that one or more workers will be eligible to make inputs into an initial schedule. Once a worker is identified as a system user in step 210, the system will provide a menu of eligible planning horizons in step 215 based on the received sign up order and the present date and time.

If the system receives a user selection in step 220 for scheduling a particular planning horizon, the system generates a list of all available shifts in step 225, and determines a residual gap for each of the available shifts.

A residual gap is determined by subtracting the expected supply from the expected demand. The expected supply is based on prior shift selections, where they exist, and an average supply for resources who have not yet scheduled. Expected demand derives from the demand profile.

As an example of an average supply calculation, consider a one week planning horizon, and a worker who is contracted for 40 hours in any week that is available to work in either of two 8 hour shifts in each of 7 days. Such a worker generates an average supply of approximately 0.36 in each of the available fourteen shifts. [40 hrs/8 hrs/14 shifts=0.36]. Thus, if 2 workers have already selected a particular shift, each of 15 workers have the same average supply for that shift as in the prior example, and the demand for a particular shift is 10, then the residual gap is 2.6. [10−2−(15×0.36)].

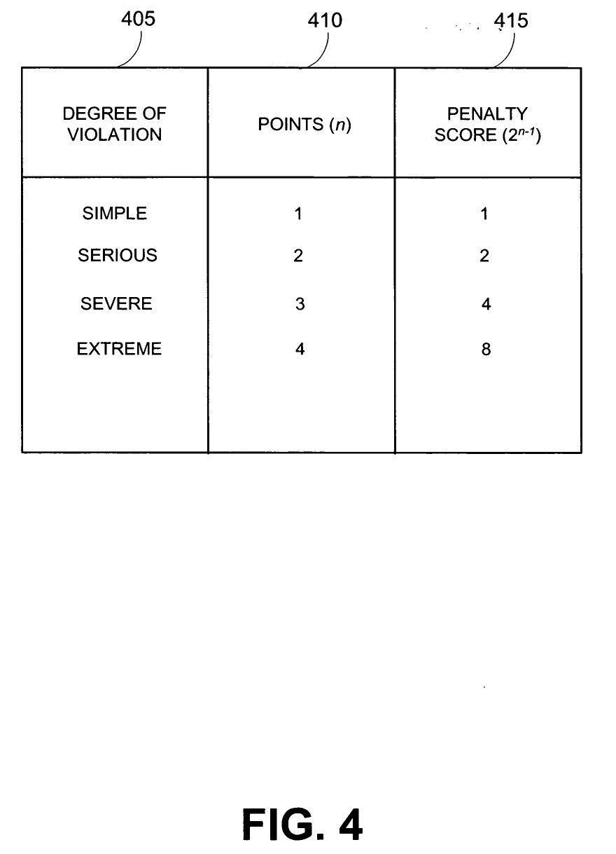

In step 230, penalty scores are determined for each available shift according to violations in shift patterns and/or other soft constraints, as will be described in more detail with reference to FIG. 4.

In optional step 235, the system may automatically assign shifts. For instance, if a staff resource has a unique skill, and that skill is needed for a particular shift in the planning horizon, then that resource may be automatically assigned to the shift having that need. Moreover, for a particular worker, the number of available shifts may be so limited that it is more efficient for the system to assign remaining shifts automatically without user interaction. Optional step 238 may be followed by an optional conditional step 238 to determine whether to continue shift selections. If all shifts have been assigned, the process advances to step 260. Otherwise, the process advances to step 240.

In optional step 240, shifts are filtered according to a predefined residual gap and/or penalty score threshold. Moreover, the threshold may be a floor or a ceiling. For instance, the system may not present any shift choices to the user in subsequent step 245 where the residual gap for that shift is less than 2. Alternatively, the system may present only those choices to a user in step 245 where the residual gap is greater than 5.

The system presents shift choices to a user in step 245 and receives and stores a shift selection based on user input in step 250. In conditional step 255, a decision is made on whether to continue shift selections. The step may be automatically determined, for example, by comparing the total number of hours scheduled for an employee during a planning horizon with the employee's full or part-time status.

If additional shift selections are required the process returns to step 230 to determine penalty scores for each available shift. If no additional shift selections are required, the process advances to step 260 and appends the sign up date to a record of stored shift selections.

Although not shown in FIG. 2, initial schedules may be generated automatically for workers who do not interact with the initial scheduling step 110 during their eligible time period.

In an automatic (or cyclic) scheduling embodiment, initial scheduling process 110 operates to automatically generate an initial schedule for all resources, without worker interaction. In one embodiment of the automatic scheduling mode, steps 225, 230, 235, 255, and 260 are performed in series.

Schedule Optimization

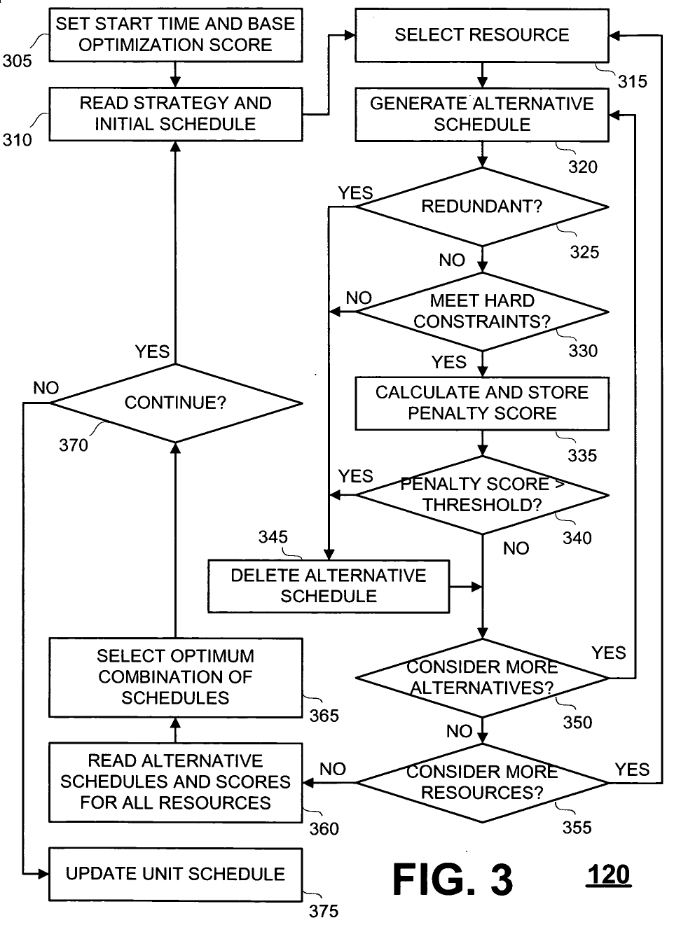

FIG. 3 is a process flow diagram for the optimization step 120 shown in FIG. 1, according to an embodiment of the invention. As shown therein, the process begins by setting a start time and a base optimization score in optional step 305. The utility of this optional initialization step will become clear from the following description.

Next, the process reads the scheduling strategy and initial schedule in step 310, selects a resource in step 315, and generates an alternative schedule in step 320. The alternative schedule is a set of shift assignments for the selected resource. Alternative schedules are generated by starting with the initial schedule, and making incremental substitutions or other changes to the initial schedule.

Advantageously, in developing alternative shifts for a given resource in step 320, the process may consider skill downgrades (the use of a higher skilled worker to satisfy the demand for a lower skilled worker). Downgrades may be processed sequentially. In a sequential mode, the optimization process 120 can first solve the demand problem for a higher skill classification, and identify instances of overcapacity in the higher skill classification. Then, prior to solving the demand problem for a lower skill classification, optimization process 120 may substitute higher skilled workers to meet the demand for lower skilled workers, to the extent of the overcapacity of higher skilled workers. In the alternative, the demand problem can be solved simultaneously, by generating alternative schedules for higher skilled workers in step 320 to cover for demand for lower skilled workers. In this latter case, the demand for a given shift may be specified in terms of upper and lower quantitative limits for each skill type, allowing for a broader range of possible solutions.

The process then advances to conditional step 325 where it is determined whether the alternative schedule is redundant with a previously scored alternative schedule for the selected resource. If the alternative schedule is not redundant, then the process advances to conditional step 330 to determine whether the alternative schedule for the selected resources meets hard constraints.

If the alternative schedule is redundant or does not satisfy hard constraints, then the process advances to step 345 where the alternative schedule is deleted. On the other hand, if the alternative schedule is not redundant and meets the hard constraints according to steps 325 and 330, respectively, then the process advances to step 335 to calculate and store a penalty score for the alternative schedule. The penalty score in optimization step 120 relates to the violation of soft constraints and will be described in more detail below.

After calculating and storing the penalty score in step 335 for the current alternative schedule, the process advances to conditional step 340 where the penalty score is compared to a threshold. If the penalty score exceeds a predetermined threshold, then the process advances to step 345 to delete the alternative schedule. If however, the penalty score does not exceed a predetermined threshold, then the process advances to a conditional step 350 where it is determined whether to consider more alternatives for the selected resource.

Where more alternatives are to be considered, the process returns to step 320 to generate another alternative schedule for the selected resource and proceed as described above. If, on the other hand, more alternatives are not to be considered for the selected resource, the process advances to conditional step 355 where it is determined whether to consider more resources.

If more resources are to be considered, then the process returns to step 315 to select a new resource and then generate alternative schedules and penalty scores for alternatives associated with the new resource in accordance with steps 320-350. If, however, it is determined in step 355 that alternative schedules have been generated and scored for all resources, then the process advances to step 360 to read alternative schedules and scores for all resources before advancing to step 365 to select an optimum combination of schedules based on the penalty scores.

In typical embodiments, step 365 operates to evenly allocate, or balance, residual gaps across all shifts in the planning horizon. However, this scheme can be modified in accordance with the scheduling strategy. Step 365 outputs an optimized schedule and an optimization grade. The optimization grade may be a function of penalty scores, calculated labor cost, or other factor(s), as specified by the scheduling strategy in step 115. In one embodiment, a commercial optimizer such as ILOG CPLEX is used to execute step 365.

The process then advances to conditional step 370 to determine whether the optimization process 120 should repeat. Conditional step 370 may consider: 1) whether the number of iterations through steps 310-365 has exceed a predetermined iteration threshold number; 2) whether a calculated elapsed time (based on the start time logged in step 305) has exceeded a time threshold; and/or 3) whether an optimization grade has failed to improve (over the base optimization grade set in step 305 or a prior optimization grade) when compared to an improvement threshold. Accordingly, a positive result on any one or more of the above inquiries could terminate optimization process 120, causing the unit schedule to be updated in step 375.

Optimization process 120 may be tailored according to the scheduling strategies revised in step 115 each time that optimization process 120 is launched.

Schedule Optimization based on Penalty Scoring

FIG. 4 is an illustration of an exemplary table used in scoring soft constraint violations in initial scheduling process 110 and/or optimization process 120, according to an embodiment of the invention. For a given soft constraint, degrees of violation may be assigned as illustrated in column 405. FIG. 4 illustrates a flexible scheme for penalty scoring based on a point value assigned to each degree of violation in column 410, and a penalty score calculation in column 415. Thus, violation of a day of week preference might be considered a severe violation having a penalty score of 4, whereas violation of a time of day preference (first shift vs. second shift) might be associated with a simple violation having a penalty score of 1. Where labor costs are defined as a soft constraint, shift premiums, overtime, and outside contracting may be assigned increasingly high degrees of violation to reflect the increasingly negative impact on staffing budgets.

Penalty scoring during optimization process 120 may also be effected by a sign-up coefficient derived from the actual sign-up order during initial scheduling process 110. For example, during initial scheduling process 110, the first worker may be assigned a sign-up coefficient of 1.0, and the last worker to sign-up may be assigned a sign-up coefficient of 0.1. Then, in penalty scoring step 335 of optimization process 120, higher penalty scores may be assigned for alternative schedules that vary from the first worker's selections in the initial scheduling process 110, as compared to similar alterations to the last worker's initial scheduling selections. In other words, the optimization process 120 can use penalty scoring to favor the preferences of workers who made selections early in the initial scheduling process 110. This feature may work in combination with step 205 so that, for example, optimization scheduling favors staff with higher seniority or other attribute.

In one embodiment of the invention, the assignment of points in column 410, and/or the penalty scoring equation in column 415 is part of the scheduling strategy step 115 used an input to the optimization process 120, providing a high degree of control to a scheduling supervisor, manager, or other administrator.

Daily Scheduling

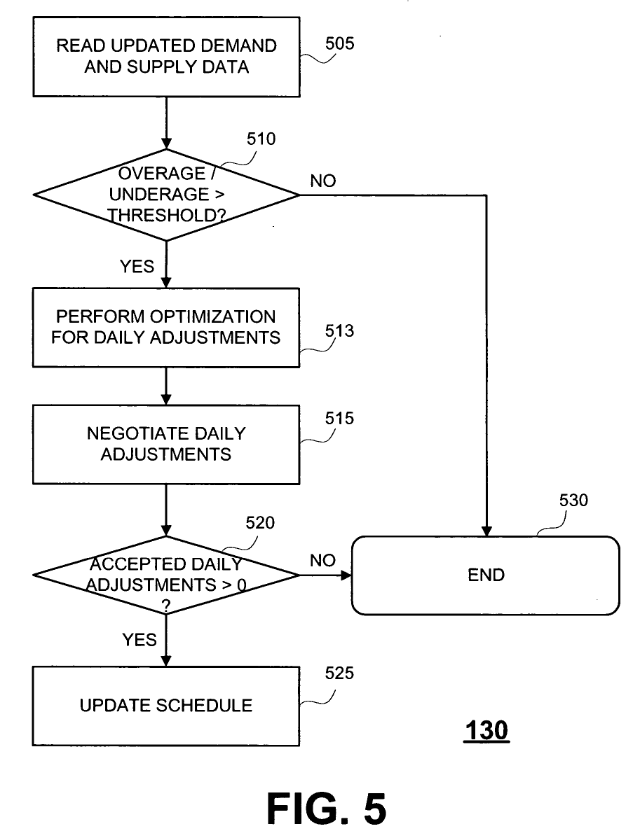

FIG. 5 is a process flow diagram for the daily scheduling step 130 in FIG. 1, according to an embodiment of the invention. Daily scheduling may be necessary where, for instance, staffing demand (workload) and/or supply (available staff) has changed in a way that limits the utility of the schedule output in step 125. As an example, replanning in step 130 may be appropriate where one or more nurses scheduled for a particular shift are unable to report to work due to illness or other personal reason.

As shown in FIG. 5, the daily scheduling process begins in step 505 by reading updated demand and supply data for a particular shift or set of shifts. The process then advances to conditional step 510, where any overage and underage is compared to a predetermined threshold. In one embodiment, the predetermined threshold is zero, so that any overage or underage is identified in conditional step 510. In another embodiment, different thresholds may be used for assessing overage and underage in step 510.

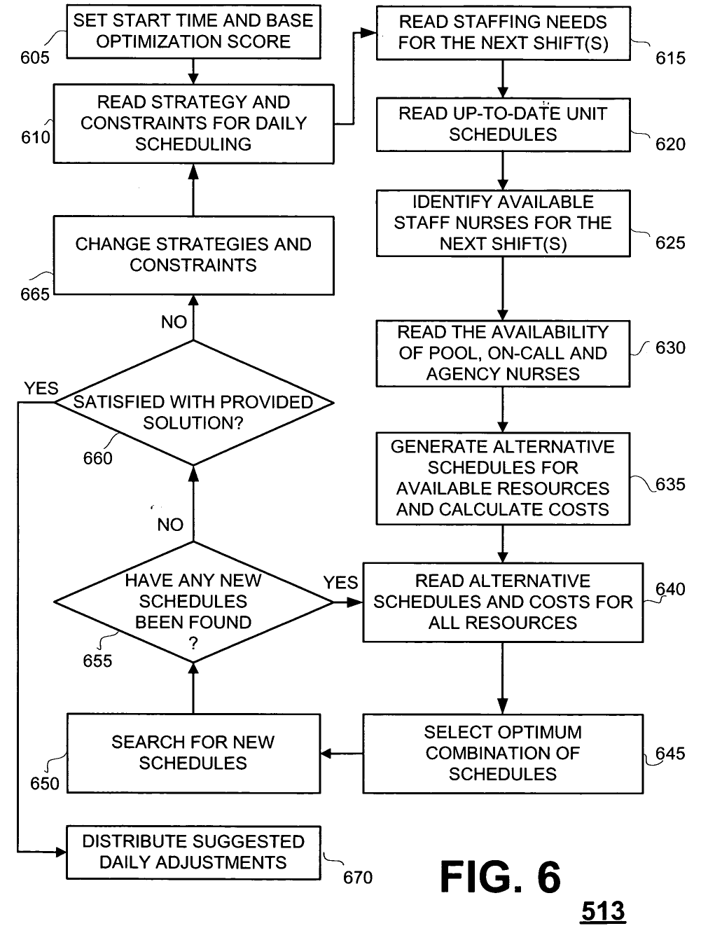

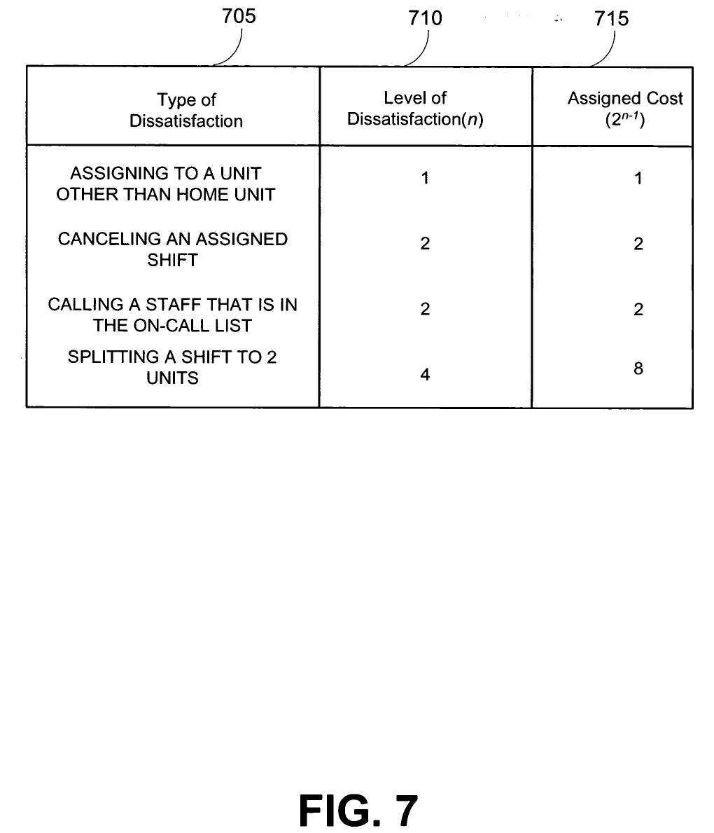

If the output of conditional step 510 is positive, then the process advances to step 513 to derive an optimal allocation of the available work force for the daily scheduling time horizon. For a given unit reviewing a given shift(s), staffing alternatives to cover a supply shortage might include, for example, borrowing excess staff from another unit, assigning overtime, or bringing in temporary workers. In another example, the result of optimization step 513 may be a recommendation to cancel scheduled workers due to a decrease in demand. Embodiments of step 513 will be discussed below with reference to FIGS. 6 and 7.

Optionally, a centralized staffing office director/coordinator may negotiate these changes with supervisors (usually in charge of several units), and managers (or the charge nurse who are responsible for a shift(s)). Step 515 represents these optional negotiations, where a manager, supervisor, or other administrator may determine whether to accept any one or more of the proposed staffing adjustments. Where staffing adjustments are accepted, conditional step 520 is in the affirmative, and the process advances to step 525 to update the unit schedules. Where the outputs of conditional steps 510 or 520 are negative, the process ends in step 530.

In an embodiment of the daily scheduling process 130, a messaging utility facilitates the process illustrated in FIG. 5. For example, a manager, supervisor, or other administrator may communicate updated demand information to other managers, supervisors, administrators, and/or contract labor sources in performing negotiation step 515.

Daily scheduling step 130 thus provides a way for a manager, supervisor, or other administrator to re-plan one or more shifts without re-planning all resources and all shifts in the planning horizon of optimization step 120.

Optimization of Daily Schedules

FIG. 6 is a process flow diagram for the daily optimization step 513 in FIG. 5, according to an embodiment of the invention. As shown in FIG. 6, the optimization process begins at a specific time and with a base schedule and score in step 605. In some applications, daily adjustments must be made within a predetermined time prior to the start of a shift. Thus, in an embodiment of step 513, the start time is recorded in step 605 to bound the run-time of the optimization step 513.

Next, the process reads the constraints and strategies for daily scheduling in step 610. The constraints may include staff qualifications needed to meet the demand. Staff preferences and profiles may also be considered in step 610. The process reads the actual staffing needs in step 615 and the up-to-date schedules in 620 (including any changes made to the schedule by shift-swap messaging step 135 and any previous daily adjustments to the schedule output in step 125).

The process reads the availability of staff resources in step 625, then reads the availability of other resources, such as overtime staff, pool staff, staff scheduled to be on-call, and the agency staff in step 630. In an alternative embodiment, steps 625 and 630 may be combined.

A branch and price approach may be used in step 635 through step 655 (branch referring to the alternative schedules, price referring to the costing of labor resources). In step 635, alternative schedules are generated for each available staff member for the planning horizon over which the daily adjustment problem is being solved. In step 640, the process reads the alternative schedules and costs associated with each schedule. In step 645, the process selects an optimal combination of these schedules. In step 650, the process searches for new schedules not yet considered in step 635.

If it is determined in conditional step 655 that new schedules have been found, then the process returns to step 640. If it is determined in conditional step 655 that no further improvement is possible for the given constraints, assignment policies and available resources, the process proceeds to conditional step 660.

Conditional step 660 provides an option of changing the daily adjustments strategies and running the model again. If the outcome of step 660 is positive, then the resultant daily schedules are distributed, for example, to a supervisor or manager. If the outcome of conditional step 660 is negative, the process advances to step 665 where new constraints and/or policies may be introduced.

Daily optimization step 513 may be based on staff dissatisfaction and/or monetary costs. As an example, any of the following alternative strategies could be read in step 610 or later adopted in step 665:
a. Optimize based on a weighted combination of monetary and dissatisfaction cost;
b. Optimize using monetary cost as the primary objective and dissatisfaction as the secondary objective;
c. Optimize the monetary cost and limit dissatisfaction for each staff rather than over all staff.
d. Optimize the dissatisfaction and limit the monetary cost associated with the adjusted schedule.

Dissatisfaction cost indicates an undesirable work pattern for a staff member whose schedule is affected by the daily adjustments. Some of the decisions that may result in dissatisfaction are: overtime assignment (esp. where mandatory); canceling an assigned shift; or assigning a staff member to a unit other than the home unit.

FIG. 7 is an illustration of a table used for assigning costs to scheduling dissatisfactions, according to an embodiment of the invention. Column 705 lists several exemplary types of dissatisfaction. For each item listed in column 705, a predetermined level of dissatisfaction is listed in column 710, and an assigned cost is listed in column 715. The costs listed in column 715 could contribute to costs read for each scheduling alternative in step 640. The cost function 2ⁿ⁻¹ in FIG. 7 is only one of many possibilities that could be used in setting a scheduling strategy.

Monetary cost refers to all forms of labor costs, including wages, overtime, and contract expenses, as applicable. In general, different pay structures may apply to different resource types. The usual goal of monetary scoring is to minimize labor costs. The use of monetary costs in steps 635 and 640 may therefore favor staff workers (e.g., regular employees of the hospital) over more expensive external resources (e.g., workers employed by the hospital on a contractual basis or through an agency).

Shift Swapping

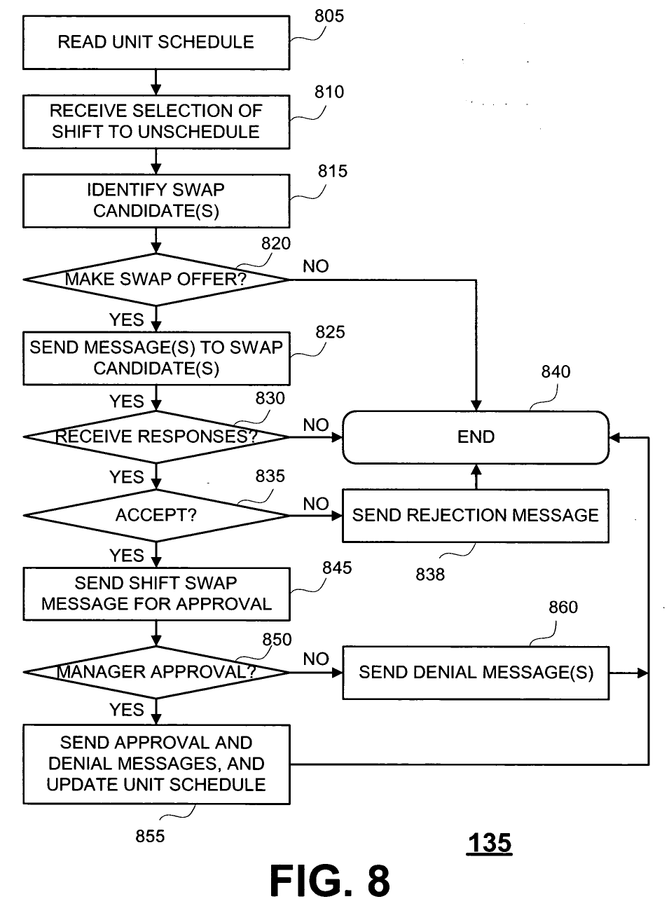

FIG. 8 is a process flow diagram for the shift swap messaging step 135 in FIG. 1, according to an embodiment of the invention. As shown therein, the process begins in step 805 by reading a unit schedule, and then advances to step 810 to receive a selection of a shift to unschedule. For a selected shift, the system will identify swap candidates in step 815 based in part on the received scheduling constraints in step 105 and the unit schedule provided in step 125.

If a user decides in conditional step 820 to contact one or more employees identified as swap candidates to offer a shift swap, then the system will send a message to these selected swap candidates in step 825 (otherwise the processes is ended in step 840). The message in step 825 may be private (i.e., seen only by the sender and intended recipient). If no swap candidates respond, then the output of conditional step 830 is negative, and the shift-swap messaging process 135 is ended. If, however, candidates do respond, then it is determined in step 835 whether their response was positive or negative.

Where the output of conditional step 835 is positive, the system sends a shift swap message for approval to a supervisor, manager, or other administrator in step 845. The process then advances to conditional step 850 for management approval. Where the output of conditional step 835 is negative, the process advances to step 838 where a rejection message is sent (indicating that the contacted candidate does not wish to swap shifts).

Where the output of conditional step 850 is positive, a manager has approved one alternative from the one or more potential swaps accepted by swap candidates, and the system will send an approval message, if appropriate, and any and all denial messages that are appropriate in step 855. Where the output of approval step 850 is negative, the process will advance to step 860, where denial messages will be sent (indicating that at least one swap was not approved), before ending in step 840. The shift-swap messaging described with reference to FIG. 8 is preferably private messaging, such as person-to-person email correspondence.

Staffing Suggestions

Periodically, the staff resources available for scheduling shifts (a constraint in step 105) needs to be updated. These updates may include the modification of staff profiles and rules to better match changing operating requirements, the addition of staff to reduce understaffing, and/or the reduction of staff to reduce overstaffing.

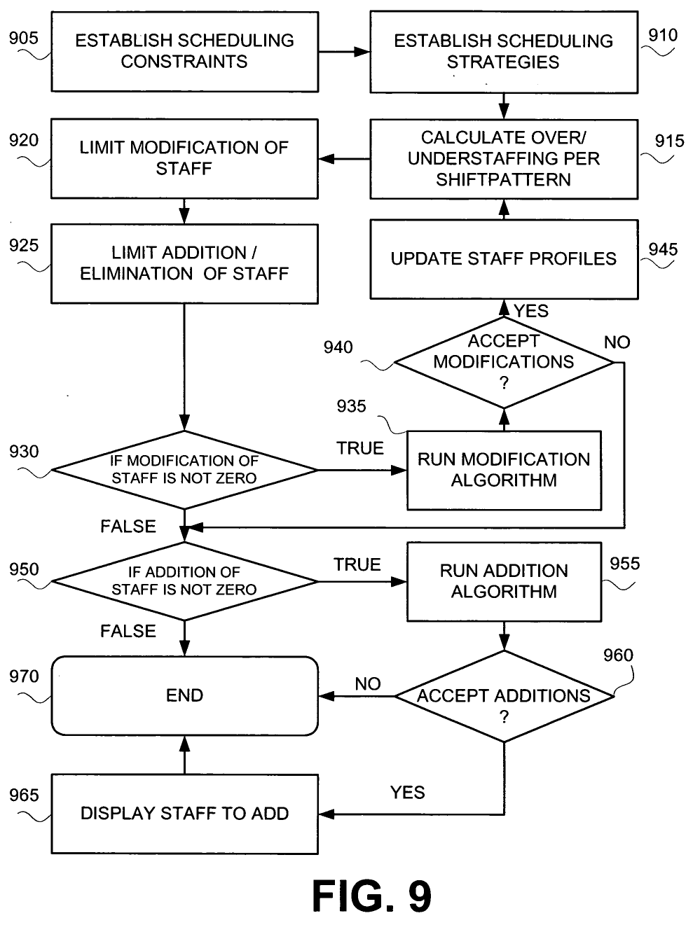

FIG. 9 is a block diagram of a functional architecture for a scheduling system, according to an embodiment of the invention. The process begins in step 905 by establishing scheduling constraints. In one embodiment of the invention, these constraints are read from step 105. In another embodiment, these constraints are read from the output unit schedule step 125. In another embodiment, scheduling constraints and parameters are input by the user in order to run scenarios on the effect of changes to constraints, such as a change to shift structures.

The process continues to step 910 by establishing scheduling strategies. In one embodiment of the invention, these scheduling strategies are read from step 115. In another embodiment, scheduling strategies are adjusted by the user in order to run scenarios on the effect of strategy changes, such as a change to the weighting of employee preferences.

In step 915, the process calculates the overstaffing and understaffing for each shift type, shift pattern, day, and period for each employee category for a representative scheduling period. In one embodiment, overstaffing and understaffing are calculated from the optimized unit schedules in step 125. Shift patterns are the percentage of types of shifts an employee is eligible to work. Examples of a shift pattern are 100 percent day shift, or 50 percent day shift/50 percent evening shift. In one embodiment, shift patterns are read from the scheduling constraints of step 105. In another embodiment these shift patterns are calculated from the optimized unit schedules in step 125.

In step 920, a user may restrict modifications to staff profile information by the process. These inputs may limit, for example, the number of staff to modify within a skill category or the types of constraints that are eligible to be modified. Other examples include limits on changes to employee shift patterns, limits on substitutions amongst staff categories, and limits on changes to full-time-equivalent status.

In step 925, the user may restrict the number of staff that can be added or reduced. This input limits the number suggested additions or reductions that will be provided within each labor category or type, for instance.

If the number of staff to modify for a particular category is not zero in step 930, the process proceeds to the modification suggestion algorithm in step 935 to derive optimal modifications of staff profiles to meet unit requirements. Then, in step 940, the user is presented with suggested staff profile modifications generated in step 935. If the user accepts the modifications in step 940, then the staff profiles are updated in step 945 and the process returns to step 915. If the user rejects the modifications in step 940, then the process advances to step 950.

If the number of staff to modify for a particular staff category is zero, or if the maximum has been reached, the process proceeds to the next category of staff. When all staffing categories have been considered in step 930, the process advances to step 950.

If the number of staff to add for a particular category is not zero in step 950, the system proceeds to the additions suggestions algorithm in step 955. If the number of staff to add for a particular staff category is zero, or if the maximum has been reached, the system proceeds to the next category of staff. When the remaining staff additions allowed by the system for all categories equals zero, the process ends in step 970.

In step 955, the process calculates the optimal number and type of staff resources to add. Then, in step 960, the user is presented with suggestions for additional staff. If the user accepts the changes, the process will display or otherwise output a suggestion for staff to add in step 965. If the user does not accept the changes in conditional step 960, then the process ends in step 970.

An exemplary modification algorithm for use in step 935 is as follows:
1. Run till maximum for the category is reached or exit through step 2 below.
2. Find the most understaffed and most overstaffed periods (lets call them deficient and excess periods). The following cases are considered—
   a. In case no understaffed and/or overstaffed period exist, the algorithm is exited.
   b. In case both of them are 4-hour periods and there is no understaffed period, the algorithm is exited, but if there is an understaffed period then the next most understaffed is assigned to be the deficient period.
   c. In case both overstaffed and understaffed periods are same, the next most understaffed period is assigned to deficient. In cases there is no other understaffed left the algorithm is exited.
3. The average number of days, hours of the excess period and hours of deficient period are found when both the understaffing of deficient period and overstaffing of excess period occurs on the same day (average using the number of 2 week periods) The average number of days (lets say twin-days) decides which type of shift pattern to change to—
   a. If twin-days>(maximum number of excess shifts in a 2 week period), then a whole single shift type nurse to another whole shift type nurse
   b. Else if twin-days is in between (maximum number of excess shifts in 2 week period and 50% of maximum, then a whole single shift nurse can be changed to a rotational shift pattern nurse
   c. Else a rotational pattern can be changed in percentages
4. In case of 3b or 3c
   Percentage change=(Average excess period hours*100)/(Average excess period hours+Average deficient period hours)
5. In case of 3c and percentage change >50, change to option 3b
6. In case of 3c no rotational nurse present, change to 3b.
7. With the options in 3, deficient and excess period, find the shift pattern to change and shift pattern to change to.
8. Check if the change is possible using nurse preferences or if there exist a nurse profile with the shift pattern to change from.
   a. In case of being false, do the fake update (updates the total information for periods without modification to profiles) and then go to step 1.
9. Add the modification information to the nursemod array list.
10. Update the staffing information (including the total and individual day information). Updates are done only for days when both the shifts can be exchanged (periods and categories taken into consideration)
11. Go to step 1

An addition algorithm for use in step 955 is as follows:
1. Run till the maximum for the category is reached or exit through 2
2. Find the two most understaffed periods (lets call them deficient1 and deficient2). FTE requirements are also calculated for both individual and combined periods. The following cases are considered—
   a. If there are no deficient periods, then exit the addition algorithm
   b. If deficient1 is 4 hour period and there is no deficient2 then exit the algorithm
   c. If both the deficient1 and deficient2 are 8-hour shifts, then check if FTE required for deficient1 is twice or more than FTE required for deficient2. If this is true, then only pass for deficient1, otherwise pass both to the algorithm.
3. If only deficient1 one is passed—
   a. If deficient1 period is day, then run Nurseone algorithm with day-only shift pattern
   b. Else if deficient1 period is night, then run Nurseone algorithm with night-only shift pattern
4. Else if deficient1 and deficient2 are both the evening periods, then run Nurseone2 algorithm with evening-only shift pattern
5. Else if one of the deficient periods is day and other is night, then run NurseCombo algorithm with day/night shift pattern
6. Else if one of deficient period is 8 hrs and the other is 4 hrs, such that the other 4 hour period makes the long shift for the 8 hour period, run NurseLong algorithm with the correct shift pattern
7. Else if one of the deficient period is 8 hrs and the other is 4 hrs and they do not compliment each other, run NurseCombo2 algorithm with the rotational shift pattern with the evening shift.
8. Go to step 1.
   Functional Architecture

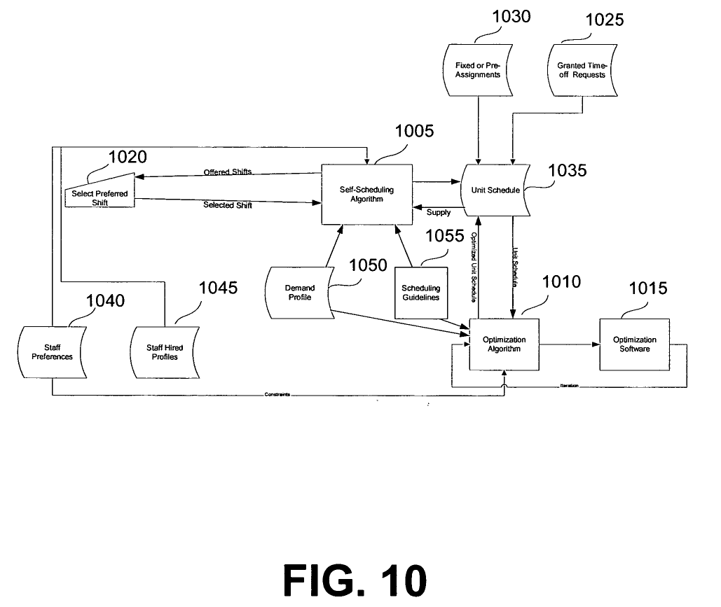

FIG. 10 is a block diagram of a functional architecture of a scheduling system, according to an embodiment of the invention. As show therein, a scheduling algorithm 1005, optimization algorithm 1010 and optimization software 1015 operate on data records indicated by unit schedule 1035, staff preferences 1040, staff hired profiles 1045, demand profile 1050, and scheduling guideline 1055. Unit schedule 1035 may be initially populated with data from granted time off request 1025 and fixed and pre-assignment data 1030. Self scheduling algorithm 1005 has an interface to an input device 1020 for operator interaction.

The functional architecture may be hosted in a network-based environment, where, for example, the self-scheduling algorithm 1005, optimization algorithm 1010, and optimization software 1015 are hosted on one or more network servers, and where terminal 1020 is a client on the network. In one embodiment, the network is the Internet, and the user terminal 1020 interfaces to the servers via a Web portal. In the alternative, or in combination, the network could be an Intranet, a LAN, a WAN, or other wired or wireless network.

The functional architecture illustrated in FIG. 10 can be configured to execute the processes described above. For example, the scheduling guidelines 1055 may be the scheduling constraints and/or scheduling strategies received in steps 105 and 115, the self-scheduling algorithm 1005 can execute the initial scheduling process 110 depicted in FIG. 2, and the optimization algorithm 1010 and optimization software 1015 may perform the optimization process 120 depicted in FIG. 3 (where the optimization software performs selection step 365).

The processes depicted in FIGS. 1-9 and described above can be implemented in software, stored in memory as required, and run on a processor capable of executing the software.

Summary

The invention described above thus overcomes the disadvantages of known systems and methods by accepting preferences from workers, providing a flexible scoring technique for optimizing schedules, and by providing methods for making substitutions in the optimized schedule.

While this invention has been described in various explanatory embodiments, other embodiments and variations can be effected by a person of ordinary skill in the art without departing from the scope of the invention.

1. A method for scheduling a plurality of staff, comprising:
receiving scheduling constraints;
preparing an initial schedule based on the scheduling constraints, the preparing based on a resource preference of at least one of the plurality of staff;
receiving scheduling strategies, the scheduling strategies being selectively input; and
optimizing the initial schedule based on the received scheduling strategies to produce an optimized schedule.

2. The method of claim 1, the preparing including:
reading an identification of the at least one of the plurality of staff;
providing a menu of eligible scheduling periods based on the identification; and
receiving a selection from the at least one of the plurality of staff based on the menu of eligible scheduling periods.

3. The method of claim 2, the preparing further including:
determining a plurality of residual gaps associating penalty scores with each of the plurality of residual gaps; and
scheduling the plurality of staff based on the penalty scores.

4. The method of claim 3, wherein the associating is based on a degree of violation of a predetermined rule and a point value associated with the degree of violation.

5. The method of claim 1, further comprising editing the optimized schedule, editing including offering a shift swap in a private message.

6. A method for scheduling a plurality of staff, comprising:
preparing a staff schedule for a first time horizon; and
optimizing the staff schedule for a second time horizon, the second time horizon being shorter than the first time horizon, the optimizing being based on a cost parameter.

7. The method of claim 6, the first time horizon being at least a day, the second time horizon being a single shift.

8. The method of claim 6, the cost parameter being at least one of a dissatisfaction cost and a monetary cost, the dissatisfaction cost based on disruption to a schedule of at least one of the plurality of staff, the monetary cost based on labor expenses.

9. The method of claim 6, the dissatisfaction cost based on a plurality of types of dissatisfaction, each of the plurality of types of dissatisfaction being associated with a level of dissatisfaction.

10. A method for optimizing a staffing schedule, comprising:
selecting a first resource type in the staffing schedule;
generating a first alternative schedule for the first resource type;
determining whether the first alternative schedule for the first resource type meets a predetermined plurality of hard constraints; and
if the first alternative schedule for the first resource type meets the predetermined plurality of hard constraints, calculating a first penalty score based on a first deviation from a plurality of soft constraints, the plurality of hard constraints being mandatory scheduling criteria, the plurality of soft constraints being optional scheduling criteria.

11. The method of claim 10, further comprising:
generating a second alternative schedule for the first resource type;
determining whether the second alternative schedule for the first resource type meets the predetermined plurality of hard constraints; and
if the second alternative schedule for the first resource type meets the predetermined plurality of hard constraints, calculating a second penalty score based on a second deviation from the plurality of soft constraints.

12. The method of claim 11, further comprising: selecting a second resource type in the schedule.

13. A method for producing a staff schedule, comprising:
identifying a first staff schedule, the first staff schedule being a candidate to swap with a second staff schedule, the first staff schedule being associated with a first staff person, the second staff schedule being associated with a second staff person, the first staff schedule and the second staff schedule being portions of the staff schedule;
sending a private message from the first staff person to the second staff person offering a swap between at least a portion of the first staff schedule and at least a portion of the second staff schedule; and
updating the staff schedule based on the private message.

14. The method of claim 13, further comprising:
determining whether a response was generated by the second staff person based on the private message;
if the response was generated, determining whether the response was an acceptance;
if the response was an acceptance, sending the response to a manager for approval; and
if the response was not an acceptance, sending a rejection message to the first staff person.

15. The method of claim 14, further comprising:
if the response was an acceptance, deciding whether to approve the acceptance, the deciding resulting in one of an approval and a denial;
if the deciding results in an approval, sending an approval message to the first staff person and the second staff person; and
if the deciding results in a denial, sending a denial message to at least the the second staff person.

16. A method for suggesting staffing changes, comprising:
calculating at least one of overstaffing and understaffing for a shift;
specifying at least one of a modification limit and an addition limit, the modification limit based on at least one of a skill type and a shift pattern, the addition limit based on a quantity of staff that can be one of added and reduced; and
determining whether the modification limit is zero.

17. The method of claim 16, further comprising, if the modification limit is not zero, running a modification algorithm, the modification algorithm suggesting changes to at least one of the skill type and shift pattern for at least one staff person.

18. The method of claim 17, further comprising:
determining whether the addition limit is zero; and
if the addition limit is not zero, running an addition algorithm, the modification algorithm suggesting at least one of the addition or reduction of staff.

19. A machine-readable medium having instructions stored thereon for execution by a processor to perform a method comprising:
receiving scheduling constraints;
preparing an initial schedule based on the scheduling constraints, the preparing based on a resource preference of at least one of the plurality of staff;
receiving scheduling strategies, the scheduling strategies being selectively input; and
optimizing the initial schedule based on the received scheduling strategies to produce an optimized schedule.

20. A machine-readable medium having instructions stored thereon for execution by a processor to perform a method comprising:
preparing a staff schedule for a first time horizon; and
optimizing the staff schedule for a second time horizon, the second time horizon being shorter than the first time horizon, the optimizing being based on a cost parameter.

21. A machine-readable medium having instructions stored thereon for execution by a processor to perform a method comprising:
selecting a first resource type in the staffing schedule;
generating a first alternative schedule for the first resource type;
determining whether the first alternative schedule for the first resource type meets a predetermined plurality of hard constraints; and
if the first alternative schedule for the first resource type meets the predetermined plurality of hard constraints, calculating a first penalty score based on a first deviation from a plurality of soft constraints, the plurality of hard constraints being mandatory scheduling criteria, the plurality of soft constraints being optional scheduling criteria.

22. A machine-readable medium having instructions stored thereon for execution by a processor to perform a method comprising:
identifying a first staff schedule, the first staff schedule being a candidate to swap with a second staff schedule, the first staff schedule being associated with a first staff person, the second staff schedule being associated with a second staff person;
sending a private message from the first staff person to the second staff person offering a swap between at least a portion of the first staff schedule and at least a portion of the second staff schedule; and
editing the staffing schedule based on the private message.

23. A machine-readable medium having instructions stored thereon for execution by a processor to perform a method comprising:
calculating at least one of overstaffing and understaffing for a shift;
specifying at least one of a modification limit and an addition limit, the modification limit based on at least one of a skill type and a shift pattern, the addition limit based on a quantity of staff that can be one of added and reduced; and
determining whether the modification limit is zero.
